(19) United States
(12) Patent Application Publication
(10) Pub. No.: US 2014/0363134 A1
(43) Pub. Date: Dec. 11, 2014

(54) OPTICAL FIBER CABLE ASSEMBLY COMPRISING OPTICAL TRACER FIBER

(71) Applicant: Corning Optical Communications LLC, Hickory, NC (US)

(72) Inventors: Dana Craig Bookbinder, Corning, NY (US); Stephan Lvovich Logunov, Corning, NY (US)

(21) Appl. No.: 14/295,844

(22) Filed: Jun. 4, 2014

Related U.S. Application Data
(60) Provisional application No. 61/864,780, filed on Aug. 12, 2013.
(60) Provisional application No. 61/833,093, filed on Jun. 10, 2013.

(51) Int. Cl. G02B 6/44

(52) U.S. Cl. CPC G02B 6/4401
USPC 385/100

(57) ABSTRACT

An optical fiber cable assembly is provided including a tracer light source and an optical tracer fiber physically coupled to or surrounded by the cable jacket and defining a tracer scattering profile comprising a relatively high scattering loss at a tracer wavelength or wavelength range λ_{T} such that light is dispersed from the optical tracer fiber along at least a portion of its length. At a bend radius of less than approximately 25 mm, the scattering profile of the optical tracer fiber generates dispersed light of a luminance that is at least about twice light generated in a zero-bend portion. The optical intensity of the tracer light source is sufficient for the luminance of the dispersed light at λ_{T} or λ_{T}* to be at least approximately 80 cd/m² at bend radii of 20 mm and below.

### RELATED APPLICATIONS

This Application claims the benefit of priority under 35 U.S.C. §119 of U.S. Application No. 61/864,780 filed on Aug. 12, 2013, and U.S. Application No. 61/833,093 filed on Jun. 10, 2013, the content of which is relied upon and incorporated herein by reference in their entirety.

### BACKGROUND

The present disclosure relates to optical fiber cable assemblies and, more particularly, to visually traceable optical fiber cable assemblies.

Typically, optical fibers that are utilized in optical fiber cable assemblies are color-coded prior to field deployment to allow for identification of particular fibers along their respective lengths. However, the present inventors have recognized that multiple cables are often deployed densely enough to make tracing individual cables nearly impossible, particularly in the context of optical fiber jumpers utilized in data centers, where relatively long jumpers connected to and between data center racks must be clearly identifiable. Additionally, as optical fiber technology penetrates consumer electronics, cables for different peripherals will become identical and be harder to trace, introducing further challenges into the installation and maintenance of home entertainment and computing systems. The present inventors have also recognized that electrical and opto-electrical cable assemblies face similar design challenges.

### SUMMARY

The subject matter of the present disclosure provides a means by which an optical fiber cable path can be fully or partially illuminated for convenient identification or to trigger a maintenance event and has applicability to a variety of applications that utilize optical fiber cable assemblies including, but not limited to, high speed data networks and consumer electronics. The subject matter of the present disclosure can also be applied to a variety of conduit applications including, for example, plumbing conduits, or other non-electrical and non-optical conduits.

In accordance with one embodiment of the present disclosure, an optical fiber cable assembly is provided comprising a tracer light source, at least one optical tracer fiber, one or more optical data transmission fibers, and a cable jacket. The optical data transmission fibers are surrounded by the cable jacket and define a data transmission profile comprising a relatively low scattering loss at a data transmission wavelength or wavelength range λ_{D} that lies in an infra-red (IR) portion of the optical spectrum. The optical tracer fiber is physically coupled to or surrounded by the cable jacket and defines a tracer scattering profile comprising a relatively high scattering loss at a tracer wavelength or wavelength range λ_{T} that lies in a visible portion of the optical spectrum such that visible light at the tracer wavelength or wavelength range λ_{T} is dispersed from the optical tracer fiber along at least a portion of its length. At a bend radius of less than approximately 25 mm, (i) the tracer scattering profile of the optical tracer fiber generates dispersed visible light of a luminance that is at least about 2 times greater than dispersed visible light generated in a zero-bend portion of the optical tracer fiber at the tracer wavelength or wavelength range λ_{T}, or an optically visible shifted tracer wavelength or wavelength range λ_{T}*, and (ii) a tracer bending loss of the optical tracer fiber is at least about 10 times greater than a data transmission bending loss of the optical data transmission fiber, at the respective wavelengths or wavelength ranges λ_{T}, λ_{D}. The optical intensity of the tracer light source is sufficient for the luminance of the dispersed visible light at λ_{T} or λ_{T}* to be at least approximately 80 cd/m² at a bend radius of less than approximately 25 mm. The optical fiber cable assembly is configured such that the dispersed visible light is visible from an exterior of the optical fiber cable assembly.

In accordance with another embodiment of the present disclosure, the optical data transmission fibers define a data transmission profile comprising a relatively low scattering loss at a data transmission wavelength or wavelength range λ_{D} that lies in a non-visible portion of the optical spectrum and the optical tracer fiber defines a tracer scattering profile comprising a relatively high scattering loss at a non-visible tracer wavelength or a non-visible tracer wavelength range λ_{T} such that non-visible light at the tracer wavelength or wavelength range λ_{T} is dispersed from the optical tracer fiber. Additionally, the optical fiber cable assembly may be configured such that the dispersed light at the tracer wavelength or wavelength range λ_{T} or an optically shifted tracer wavelength or wavelength range λ_{T}* is detectable from an exterior of the optical fiber cable assembly.

In accordance with yet another embodiment of the present disclosure, an optical fiber cable assembly is provided comprising a tracer light source, at least one optical tracer fiber, one or more optical data transmission fibers, and a cable jacket. The optical data transmission fibers are surrounded by the cable jacket and define a data transmission profile comprising a relatively low scattering loss at a data transmission wavelength or wavelength range λ_{D} that lies in an IR portion of the optical spectrum. The optical tracer fiber is physically coupled to or surrounded by the cable jacket and defines a tracer scattering profile comprising a relatively high scattering loss at a tracer wavelength or wavelength range λ_{T} that lies in a blue portion of the optical spectrum such that blue light at the tracer wavelength or wavelength range λ_{T} is dispersed from the optical tracer fiber along its length. The cable jacket, cabling media disposed within the cable jacket, or both, are configured to impart a blue-to-green shift in visible light scattered from the optical tracer fiber as it propagates from the optical tracer fiber such that green light at an optically shifted tracer wavelength or wavelength range λ_{T}* is visible from an exterior of the optical fiber cable assembly. The optical intensity of the tracer light source at the tracer wavelength or wavelength range λ_{T} is sufficient for the luminance of the dispersed visible light at λ_{T} or λ_{T}* to be at least approximately 80 cd/m².

Additional embodiments are disclosed and claimed. Although the concepts of the present disclosure are described herein with primary reference to just a few different types of optical fiber cable assemblies, it is contemplated that the concepts will enjoy applicability to any optical fiber cable assembly or conduit application, regardless of the type of fibers, cabling media, or cable jackets utilized therein. Further, additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiments and together with the description serve to explain principles and operation of the various embodiments.

### BRIEF DESCRIPTION OF THE DRAWINGS

FIG. 1 illustrates an optical fiber cable assembly comprising an optical tracer fiber according to one embodiment of the present disclosure;

FIG. 2 illustrates an optical fiber cable assembly comprising an optical tracer fiber according to another embodiment of the present disclosure;

FIG. 3 illustrates an optical fiber cable assembly comprising an optical tracer fiber according to yet another embodiment of the present disclosure;

FIG. 4A illustrates some contemplated tracer fiber configurations according to the present disclosure;

FIG. 4B illustrates refractive index n and numerical aperture NA ranges for some contemplated tracer fibers according to the present disclosure;

FIG. 5 illustrates the injection of tracer light into an optical fiber cable assembly of the present disclosure.

FIG. 6 illustrates an optical fiber cable assembly comprising an integrated optical tracer fiber according to one embodiment of the present disclosure; and

FIG. 7 illustrates an optical fiber cable assembly comprising an integrated optical tracer fiber according to another embodiment of the present disclosure.

### DETAILED DESCRIPTION

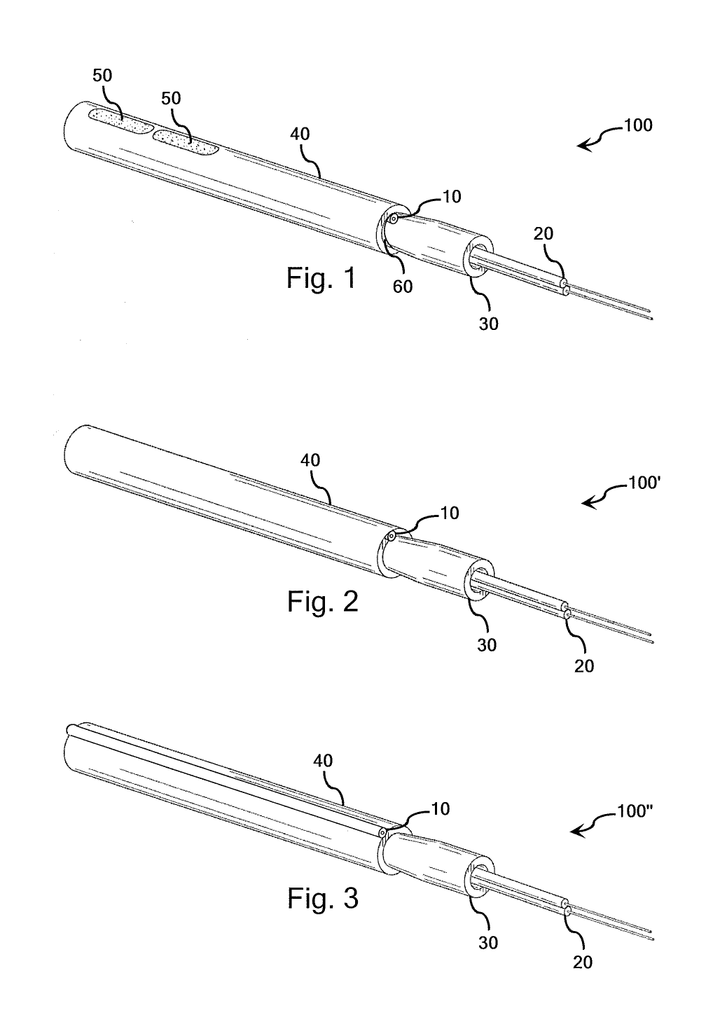

FIGS. 1-3 illustrate optical fiber cable assemblies 100, 100′, 100″ that comprise an optical tracer fiber 10, one or more optical data transmission fibers 20, cabling media 30, and a cable jacket 40. Although, as is described in detail below, these cable components may take a variety of conventional and yet-to-be developed forms, the concepts of the present disclosure are illustrated herein with reference to relatively simple cable configurations to preserve clarity. One skilled in the art of optical fiber cables will appreciate that a variety of component designs may be utilized to construct an optical fiber cable assembly including, for example, a variety of different types, numbers and configurations of single mode and multi-mode data transmission fibers. Cable assemblies according to the present disclosure may also utilize a variety of different types of cabling media and cable jackets, examples of which are presented in more detail below.

The optical data transmission fibers 20 are surrounded by the cable jacket 40 and define a data transmission profile that comprises a relatively low scattering loss (in some embodiments <10 dB/km, in some embodiments <3 dB/km, in some embodiments <1 dB/km and in some embodiments <0.5 dB/km) at a data transmission wavelength or wavelength range λ_{D}, which typically lies in an IR portion of the optical spectrum (i.e., at one or more transmission wavelengths greater than 700 nm, in some embodiments at one or more transmission wavelengths from about 700 to about 1700 nm, in some embodiments at one or more transmission wavelengths about 850 to about 1650 nm). In contrast, the optical tracer fiber 10 is physically coupled to, or surrounded by, the cable jacket 40 and defines a tracer scattering profile that comprises a relatively high scattering loss (in some embodiments >15 dB/km, in some embodiments >20 dB/km in some embodiments >40 dB/km and in some embodiments >60 dB/km) at a tracer wavelength or wavelength range λ_{T}, which lies in a visible portion of the optical spectrum (e.g., at one or more transmission wavelengths between about 400 nm and about 700 nm), such that visible light at the tracer wavelength between about 400 nm and about 700 nm or a wavelength range λ_{T} between about 400 nm and about 700 nm, is dispersed from the optical tracer fiber 10 along at least a portion of its length. It is noted that reference herein to “relatively” low and high scattering losses should be taken as a definite reference to specific portions of the data transmission profile of the particular fiber at issue, i.e., those portions of the profile where scattering losses are low or high compared to other portions of the profile.

The optical data transmission fibers 20 contemplated herein are designed for efficient data transmission at a given data transmission wavelength or wavelength range λ_{D}. Although the given data transmission wavelength or wavelength range λ_{D} may be in a visible or infrared (IR) portion of the optical spectrum, in some embodiments, the data transmission wavelength or wavelength range λ_{D} falls in a IR portion of the optical spectrum, e.g., a portion of the IR spectrum longer than about 700-800 nm.

In the optical fiber cable assembly 100 illustrated in FIG. 1, the optical tracer fiber 10 is positioned within an inside diameter of the cable jacket 40 and the cable jacket 40, which is visible from an exterior of the optical fiber cable assembly 100, is translucent or transparent to the tracer wavelength or wavelength range λ_{T}, or an optically visible shifted tracer wavelength or wavelength range λ_{T}*, along at least a portion of a length of the optical fiber cable assembly 100. It is contemplated that the cable jacket 40 may comprise a fluorescent component that generates the optically visible shifted tracer wavelength or wavelength range λ_{T}* upon propagation of the tracer wavelength or wavelength range λ_{T} from the optical tracer fiber 10 through the cable jacket 40. It is also contemplated that the tracer wavelength or wavelength range λ_{T} and the shifted tracer wavelength or wavelength range λ_{T}* may lie in the blue, green or red portion of the optical spectrum.

Regardless of whether the cable jacket 40 is provided with a fluorescent or some other type of transmissive component, it is contemplated that the cable jacket 40 may be otherwise compositionally or structurally varied continuously or discontinuously along its length to permit the dispersed visible light at the tracer wavelength or wavelength range λ_{T} or the shifted tracer wavelength or wavelength range λ_{T}* to be visible from an exterior of the optical fiber cable assembly. For example, in one embodiment, the cable jacket 40 is provided with transmissive (e.g., fluorescent), translucent, or transparent regions 50 that are configured to permit the propagation or transmission of the tracer wavelength or wavelength range λ_{T} or the optically visible shifted tracer wavelength or wavelength range λ_{T}* to the exterior of the cable jacket 40. These transparent regions 50 may be provided as transmissive, translucent, or transparent voids or plugs in the cable jacket 40 or may be provided as a substantially continuous strip along the cable jacket 40. It is also contemplated that some optical fiber cable assemblies will utilize hygroscopic tape, or hygroscopic powder, or some other structure that is interposed between the optical tracer fiber 10 and the cable jacket 40. In which case, it will be advantageous to ensure that the hygroscopic material or other interposing structure is also provided with transmissive, translucent, or transparent regions that permit propagation of the tracer wavelength or wavelength range λ_{T} or the optically visible shifted tracer wavelength or wavelength range λ_{T}*.

In the embodiment illustrated in FIG. 2, the optical tracer fiber 10 is positioned between an inside diameter of the cable jacket 40 and an outside diameter of the cable jacket 40, i.e., within the body of the cable jacket 40. The cable jacket 40, which is visible from an exterior of the optical fiber cable assembly 100′, is again configured to be translucent or transparent to the tracer wavelength or wavelength range λ_{T} or the optically visible shifted tracer wavelength or wavelength range λ_{T}* along at least a portion of a length of the optical fiber cable assembly 100′. It is contemplated that the embodiment illustrated in FIG. 2 may also take advantage of fluorescence in the cable jacket 40, i.e., by configuring the composition of the cable jacket 40 so that it transmits the optically visible shifted tracer wavelength or wavelength range λ_{T}* along at least a portion of a length of the optical fiber cable assembly 100′.

In the embodiment illustrated in FIG. 3, the optical tracer fiber 10 is positioned on an outside diameter of the cable jacket 40, or at least partially extends beyond an outside diameter of the cable jacket 40. In this manner, the visible tracer wavelength or wavelength range λ_{T} or the optically visible shifted tracer wavelength or wavelength range λ_{T}* can both be readily viewed when the light is scattered and dispersed from the optical tracer fiber 10. In some embodiments, the optical tracer fiber 10 will comprise a tracer jacket, which will also need to be made transmissive of, or translucent or transparent to, the visible tracer wavelength or wavelength range λ_{T} or the optically visible shifted tracer wavelength or wavelength range λ_{T}*.

In each of the above-described embodiments, it is noted that dispersed light at the tracer wavelength or wavelength range λ_{T} or an optically shifted tracer wavelength or wavelength range λ_{T}* typically falls in the visible portion of the optical spectrum but it is contemplated that tracer wavelength or wavelength range λ_{T} may fall in an IR or other non-visible portion of the optical spectrum. In which case, suitable monitoring equipment sensitive to the non-visible light can be provided to detect the tracer light. Further, it is contemplated that the optical tracer fiber 10 may comprise a coated or uncoated optical fiber, which may or may not include an exterior buffer tube or exterior buffer coating. Suitable tracer fibers include, but are not limited to, the fiber configurations disclosed in US PG Pub. No. 2011/0122646 (“Optical Fiber Illumination Systems and Methods).

Embodiments contemplated herein include, but are not limited to, silica (Si0₂) glass-based optical tracer fibers. Regardless of the particular type of optical tracer fiber 10 that is utilized in accordance with the concepts of the present disclosure, it is noted that the optical tracer fiber 10 may comprise continuous or discontinuous optical scattering sites along its length. These scattering sites can be configured to impart high bulk Rayleigh scattering at the tracer wavelength or wavelength range λ_{T} (relative to a degree of Rayleigh scattering at the data transmission wavelength or wavelength range λ_{D}). These optical scattering sites may comprise, for example, random or non-periodic fiber core voids (often referred to as “airlines”) or a raised index compound, relative to the core, at an outer radius of the optical tracer fiber (e.g., by doping with a GeO₂, TiO₂, or Al₂O₃ updopant).

In one embodiment, the tracer wavelength or wavelength range λ_{T} lies in the blue portion of the optical spectrum and the cable jacket 40, cabling media 30 disposed within the cable jacket 40, or both, are configured to impart a blue-to-green shift in visible light scattered from the optical tracer fiber 100, 100′, 100″. The resulting visible signal is very effectively and efficiently produced because Rayleigh scattering in blue is very efficient so the optical tracer fiber 10 can be configured to emit vibrant blue light throughout its length. This vibrant blue light is preferably then converted to green because the human eye is about 20 times more sensitive to green light than blue. Alternatively, it is contemplated that the aforementioned conversion can be from the invisible, blue, or green portion of the optical spectrum to the red portion of the optical spectrum.

It is contemplated that visibility can also be enhanced by pulsing the tracer wavelength or wavelength range λ_{T}, preferably at a frequency of less than approximately 40 Hz. Additionally, it is contemplated that zero-bend, patterned tracer emission may be enabled by configuring the tracer scattering profile of the optical tracer fiber 100, 100′, 100″ and the optical intensity of the optical tracer source such that visible light at the tracer wavelength or wavelength range λ_{T} is dispersed from zero-bend portions of the optical tracer fiber at a luminance that is at least about 80 cd/m². In this manner, the optical fiber cable assembly can be configured such that the dispersed visible light λ_{T}, λ_{T}* is visible from an exterior of the optical fiber cable assembly as a color-coded, patterned, or symbolic emission.

For bend-sensitive optical tracer fibers according to the present disclosure, it is contemplated that, at a bend radius of less than approximately 25 mm, the tracer scattering profile of the optical tracer fiber generates dispersed visible light of a luminance that is at least about 2 times greater than dispersed visible light generated in a zero-bend portion of the optical tracer fiber. At the same bend radius, the tracer bending loss of the optical tracer fiber 10 is typically at least about 10 times greater than a data transmission bending loss of the optical data transmission fiber 20, at the respective wavelengths or wavelength ranges λ_{T}, λ_{D}.

The optical fiber cable assemblies 100, 100′, 100″ can be provided with a tracer light source, the optical intensity of which is sufficient for the luminance of the dispersed visible light at λ_{T} or λ_{T}* to be at least approximately 80 cd/m² at a bend radius of less than approximately 20 mm. This dispersed visible light is a function of the tracer scattering profile of the optical tracer fiber 10 and is visible from the exterior of the optical fiber cable assembly 100, 100′, 100″ due to the location of the optical tracer fiber 10 and/or the configuration of the cabling media 30 and cable jacket 40. In one embodiment, at a bend radius of between approximately 10 mm and approximately 25 mm, the tracer scattering profile of the optical tracer fiber generates dispersed visible light of a luminance that is at least about two times greater than dispersed visible light generated in a zero-bend portion of the optical tracer fiber. In another embodiment, at a bend radius of between approximately 10 mm and approximately 25 mm, the tracer scattering profile of the optical tracer fiber is engineered to generate at least about a three-fold increase in the luminance of the dispersed visible light, relative to a zero-bend condition. In another more bend-sensitive embodiment, at a bend radius of between approximately 5 mm and approximately 15 mm, the tracer scattering profile of the optical tracer fiber is engineered to generate dispersed visible light of a luminance that is at least about five times greater than dispersed visible light generated in a zero-bend portion of the optical tracer fiber. In a further embodiment, at a bend radius of between approximately 2 mm and approximately 10 mm, the tracer scattering profile of the optical tracer fiber is engineered to generate dispersed visible light of a luminance that is at least about ten times greater than dispersed visible light generated in a zero-bend portion of the optical tracer fiber. At even smaller bend radii, e.g., between approximately 2 mm and approximately 5 mm, it is contemplated that the tracer scattering profile of the optical tracer fiber can be engineered to generate dispersed visible light of a luminance that is at least about fifteen times greater than dispersed visible light generated in a zero-bend portion of the optical tracer fiber.

Noting that the preferred bend sensitivity of the optical data transmission fiber utilized in a particular cable assembly will vary across applications, it may be preferable to classify optical fiber cable assemblies according to the present disclosure in terms of the relative bend sensitivities of the data transmission fibers and the optical tracer fibers. For example, where the optical data transmission fibers are characterized by a bend sensitivity threshold at a data transmission bend radius r₁, i.e., the bend radius below which there is a transmission loss of more than about 10%, the tracer scattering profile of the optical tracer fiber can be engineered to generate at least about a two-fold increase in the luminance of the dispersed visible light at a bend sensitive tracer bend radius r₂ that is slightly larger than the data transmission bend radius r₁. In one embodiment, the bend sensitive tracer bend radius r₂ is within approximately 5 mm of the bend sensitive data transmission bend radius r₁. Closer bend radii differences, e.g., on the order of one or two mm, or less, are also contemplated, as are larger bend radii differences. In this manner, there will be a marked increase in bend-sensitive tracer emission as the cable assembly approaches the bend sensitivity threshold of the data transmission fibers.

The various embodiments disclosed herein are well-suited for bend-only tracer emission. It is also contemplated that the various embodiments disclosed herein are also well-suited for emission along the full, or nearly full, length of the fiber, with enhanced tracer emission at particular bend radii. In the case of full or nearly full length emission, it is contemplated that the tracer scattering profile of the optical tracer fiber 10 and the optical intensity of the optical tracer source, which is described in more detail below with reference to FIG. 5, are such that visible light at the tracer wavelength or wavelength range λ_{T} is dispersed from zero-bend portions of the optical tracer fiber 10 at a luminance that is at least about 10 cd/m² or, more particularly, between approximately 10 cd/m² and approximately 50 cd/m². At bend radii of approximately 20 mm and below, the tracer scattering profile of the optical tracer fiber 10 and the optical intensity of the optical tracer source can be selected such that the dispersed visible light λ_{T}, λ_{T}* comprises a luminance between approximately 100 cd/m² and approximately 200 cd/m². For example, it is contemplated that a 100 mW tracer light source providing approximately 500 cd/m² of luminance for green light at 550 nm, would be sufficient to feed tracer fibers of the present disclosure provided at lengths of approximately 50 meters.

In cases, of bend-only tracer emission, it is contemplated that the tracer scattering profile of the optical tracer fiber 10 should be selected such that (i) visible light at the tracer wavelength or wavelength range λ_{T} is dispersed from zero-bend portions of the optical tracer fiber 10 at a luminance that is less than 10 cd/m² and that (ii) visible light λ_{T}, λ_{T}* is dispersed from bent portions of the optical tracer fiber 10, e.g., at bend radii of approximately 20 mm and below, at a luminance between approximately 80 cd/m² and approximately 200 cd/m². In some contemplated embodiments, the optical tracer fiber 10 is configured to be particularly sensitive to optical bending losses to enhance optical scattering at bends in the cable assembly 100. In this manner, light scattered from the tracer fiber 10 will be more intense in locations where the cable assembly 100 is bent, providing for easy identification of cable kinks or sources of potential high macrobend loss in the data transmission fiber 20. This could be particularly valuable when a jumper cable assembly is within a cluster of cables in a data center, i.e., where small bends are not otherwise easy to identify.

For example, in one embodiment, it is contemplated that the optical tracer fiber 10 can be configured for enhanced scattering at bend radii between about 2 mm and about 20 mm, i.e., scattering that is sufficient to permit visual identification of bends in the optical fiber at bend radii between about 2 mm and about 20 mm. In embodiments where the cable assembly 100 comprises data transmission fibers 20, it is contemplated that the bending loss of the optical tracer fiber 10 can be at least about twice that of the data transmission fiber 20 at bend radii between about 2 mm and about 20 mm. In other embodiments, it may be preferable to ensure that the bending loss in the optical tracer fiber 10 is at least about five times that of the data transmission fiber 20, or at least about ten times greater than that of the data transmission fiber 20, at the same wavelength. In embodiments where the cable assembly does not comprise a data transmission fiber, it is contemplated that the enhanced scattering of the optical tracer fiber 10 will be sufficient to permit visual identification of bends in the optical fiber at bend radii between about 2 mm and about 20 mm.

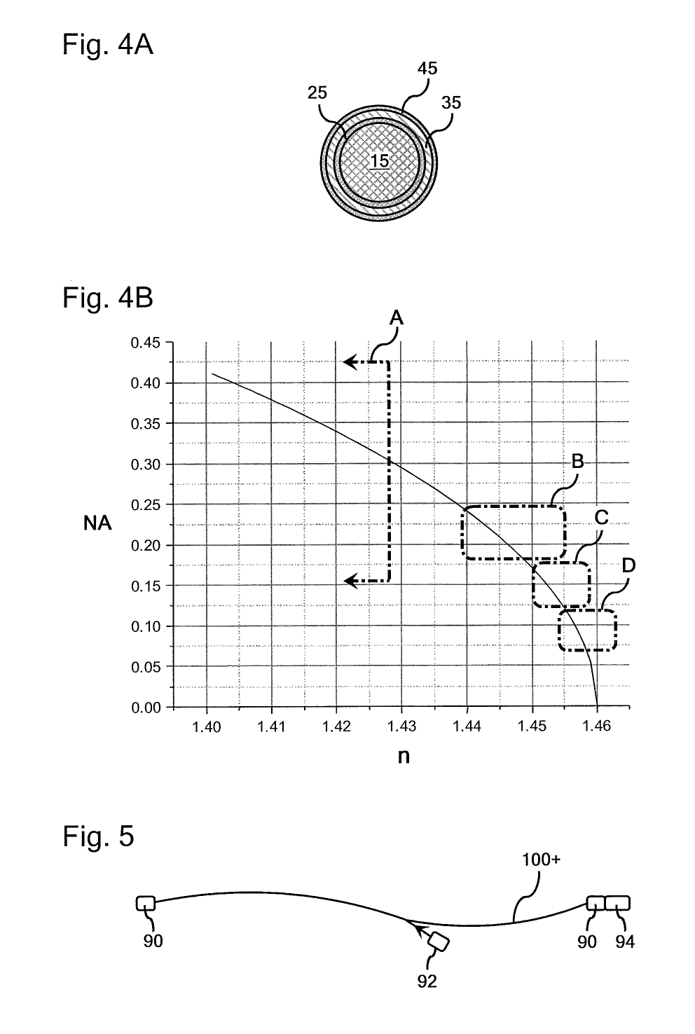

It is contemplated that a variety of tracer fiber configurations will be suitable for use as the tracer fibers 10 described and claimed herein—including conventional optical fibers and as yet undeveloped optical fibers. Referring to FIG. 4A, contemplated tracer fiber configurations may comprise a silica-based glass core 15, which may or may not comprise random or non-periodic fiber core airlines, a primary cladding layer 25 surrounding the core 15, a secondary cladding or coating 35 surrounding the primary cladding layer 25, and a scattering layer 45 surrounding the secondary cladding or coating 35. The primary cladding layer 25 may comprise silicon, a fluoroacrylate polymer, or F-doped glass, each with a refractive index n lower than that of the silica forming the glass core 15. In cases where the primary cladding layer 25 comprises F-doped glass, it is contemplated that conventional telecom fiber comprising an acrylate primary cladding layer 25 may be utilized. The secondary cladding or coating 35 may also be provided in the form of an acrylate polymer, which is also typical for conventional telecom fiber. Contemplated alternative embodiments utilize the core 15 with airlines and the secondary cladding 35 only, eliminating the primary cladding layer 25. The scattering layer 45 may be provided as an acrylate polymer and may include white ink, a flame retardant composition, etc.

As is illustrated in FIG. 4B, the bend sensitivity of the tracer fiber 10 can be engineered through proper selection of the refractive index n of the primary cladding layer 25, the numerical aperture of the optical tracer fiber 10, or both. FIG. 4B provides refractive index n and numerical aperture NA ranges for tracer fibers A of low bend sensitivity, tracer fibers B of intermediate bend sensitivity, tracer fibers C of relatively high bend sensitivity, and tracer fibers D of very high bend sensitivity. For cases where NA<0.17, F-doped glass should typically be used, since the refractive indices of polymers can change with temperature, which would affect bend sensitivity. Generally, the primary cladding layer 25 needs to have a lower refractive index than the core 15. It is contemplated that this can be achieved by either down-doping the silica primary cladding layer 25 with dopants that decrease the refractive index of the primary cladding layer 25, like fluorine or boron, or by up-doping the core 15 with refractive increasing dopants like GeO₂, P₂O₅, Al₂O₃, TiO₂, etc.

FIG. 5 illustrates two different ways tracer light may be injected into an optical fiber cable assembly 100+ of the present disclosure. Generally, the optical fiber cable assembly 100+ may comprise optical connectors 90 and/or one or more tracer light injection ports 92. A tracer light source 94, e.g., a laser or LED operating at the tracer wavelength or in the tracer wavelength range λ_{T}, can be optically coupled to one of the optical connectors 90 to inject light into the optical tracer fiber of the cable assembly 100+. Alternatively, or additionally, a cable span can be provided with a tracer light injection port 92 to permit light at the tracer wavelength or in the tracer wavelength range λ_{T} to be injected into the cable assembly 100+ at any point between the optical connectors 90 of the cable assembly 100+. The mid-span tracer light injection port 92 thus provides for injection of the tracer light while preserving uninterrupted operability of the optical connectors 90.

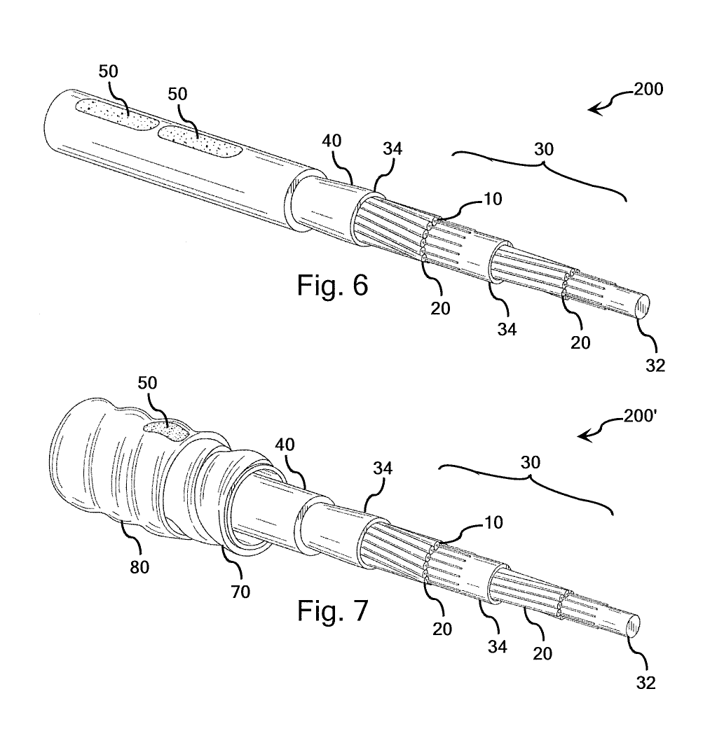

The optical data transmission fibers 20 may comprise a single fiber, paired fibers, a plurality of optical fibers configured as an optical fiber ribbon, concentric bundles of optical fibers, or any other conventional or yet-to-be developed optical fiber configuration. FIGS. 6 and 7 illustrate embodiments where the optical data transmission fibers 20 comprise concentric bundles of optical fibers. These embodiments are particularly well-suited for describing embodiments of the present disclosure where the optical tracer fiber 10 is integrated with the optical data transmission fibers 20. It is contemplated that the optical tracer fiber 10 may assume any of the fiber locations within the optical fiber cable assembly 200, regardless of where it lies in the cross section of the assembly 200—although an outermost position is most likely preferable. In such embodiments, which are not limited to cases where the optical data transmission fibers 20 comprise concentric bundles of optical fibers, care should be taken to ensure that the cabling media 30, which may include strength members 32, buffer tubes 34, etc., permits propagation of the tracer wavelength or wavelength range λ_{T} or an optically visible shifted tracer wavelength or wavelength range λ_{T}* from the optical tracer fiber 10 to the cable jacket 40 along at least a portion of a length of the optical fiber cable assembly 200.

It is noted that optical fiber cabling media 30 may take a variety of conventional and yet-to-be developed forms. For example, where an optical fiber cable assembly comprises an optical waveguide disposed within a protective tube, the optical waveguide must be further protected within the tube and a certain amount of relative movement between the optical waveguide and the tube should be permitted. To this end, it is not unusual to provide water blocking tapes, yarns, woven binder threads, dry inserts, thixotropic greases, strength members, buffer tubes, fiber coatings, etc., as cabling media in the space between the optical fibers of the cable and the cable jacket, and in the space between the optical fibers themselves. These types of materials are referred to herein collectively as cabling media.

For example, the optical fiber cable assemblies 200, 200′ illustrated in FIGS. 6 and 7 are, respectively, un-armored and armored cable assemblies that comprises concentric bundles of tight-buffered fibers 10, 20 within a polymer or flame retardant polymer jacket 40. The jacket 40 contains the fibers 10, 20, a steel or dielectric strength member 32, and respective buffer tubes 34. The fibers in FIG. 7 are further protected by a flexible, spirally wrapped or corrugated, aluminum or steel interlocking armor 70, which is surrounded by a polymer or flame-retardant polymer outer jacket 80. Of course, it is contemplated that the concepts of the present disclosure will enjoy applicability to a wide variety of optical fiber cable configurations and should not be limited to the embodiments of FIGS. 1-3 and 6-7.

In the embodiments of FIGS. 6 and 7, and other similar embodiments, the cabling media 30 is configured such that it permits propagation of the tracer wavelength or wavelength range λ_{T} or the optically visible shifted tracer wavelength or wavelength range λ_{T}* from the optical tracer fiber 10 to the outermost cable jacket 40, 80, continuously or discontinuously along the length of the optical fiber cable assembly 200, 200′. The cable jacket 40, 80 is visible from an exterior of the optical fiber cable assembly 200, 200′ and permits the tracer wavelength or wavelength range λ_{T} or the optically visible shifted tracer wavelength or wavelength range λ_{T}* to be viewed from the exterior of the optical fiber cable assembly 200, 200′. To this end, the cabling media 30 may comprise transmissive, translucent, or transparent regions 50, e.g., voids or plugs, that are configured to permit the propagation of the tracer wavelength or wavelength range λ_{T} or transmission of the optically visible shifted tracer wavelength or wavelength range λ_{T}*. In addition, it is contemplated that the cabling media 30, the cable jacket 40, 80, or both, may comprise a fluorescent component that generates the optically visible shifted tracer wavelength or wavelength range λ_{T}* upon propagation of the tracer wavelength or wavelength range λ_{T} from the optical tracer fiber 10 through the cabling media.

In the embodiments of FIGS. 6 and 7, and other embodiments where the optical tracer fiber 10 is integrated with the optical data transmission fibers 20, it is contemplated that the optical tracer fiber 10 and the optical data transmission fibers 20 may define substantially identical optical scattering and transmission profiles, including, for example, a relatively low scattering loss at the data transmission wavelength or wavelength range λ_{D}. Alternatively, it is also contemplated that the optical tracer fiber 10 and the optical data transmission fibers 20 may define substantially identical optical transmission profiles but substantially distinct optical scattering profiles. It is further contemplated that the optical tracer fiber 10 and the optical data transmission fibers 20 may define substantially distinct optical scattering and transmission profiles, where, for example, a degree of scattering at the tracer wavelength or wavelength range λ_{T} in an optical data transmission fiber 20 is substantially less than a degree of scattering at the tracer wavelength or wavelength range λ_{T} in the optical tracer fiber 10.

It is also noted that recitations herein of “at least one” component, element, etc., should not be used to create an inference that the alternative use of the articles “a” or “an” should be limited to a single component, element, etc. For example, reference herein to “an optical tracer fiber” should not be read to limit the description or claims to a single optical tracer fiber.

It is noted that recitations herein of a component of the present disclosure being “configured” in a particular way, to embody a particular property, or to function in a particular manner, are structural recitations, as opposed to recitations of intended use. More specifically, the references herein to the manner in which a component is or “configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed inventive technology or to imply that certain features are critical, essential, or even important to the structure or function of the claimed inventive technology. Rather, these terms are merely intended to identify particular aspects of an embodiment of the present disclosure or to emphasize alternative or additional features that may or may not be utilized in a particular embodiment of the present disclosure.

For the purposes of describing and defining the present inventive technology it is noted that the terms “substantially,” “about,” and “approximately” are utilized herein to represent the inherent degree of uncertainty that may be attributed to any quantitative comparison, value, measurement, or other representation. The terms are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

For example, although the various embodiments of the present disclosure are described in the context of an optical fiber cable assembly that is free of electrical components, it is contemplated that the concepts of the present disclosure, particularly the optical tracer fiber, may be utilized in electrical or opto-electrical cable assemblies. The disclosed tracer fiber may also be utilized in a variety of conduit applications including, for example, plumbing conduits, or other non-electrical and non-optical conduits.

It will be apparent to those skilled in the art that various modifications and variations can be made without departing from the spirit or scope of the inventive technology. Since modifications combinations, sub-combinations and variations of the disclosed embodiments incorporating the spirit and substance of the inventive technology may occur to persons skilled in the art, the inventive technology should be construed to include everything within the scope of the appended claims and their equivalents.

It is noted that one or more of the following claims utilize the term “wherein” as a transitional phrase. For the purposes of defining the present inventive technology, it is noted that this term is introduced in the claims as an open-ended transitional phrase that is used to introduce a recitation of a series of characteristics of the structure and should be interpreted in like manner as the more commonly used open-ended preamble term “comprising.”

1. An optical fiber cable assembly comprising a tracer light source, at least one optical tracer fiber, one or more optical data transmission fibers, and a cable jacket, wherein:
the optical data transmission fibers are surrounded by the cable jacket and define a data transmission profile comprising a relatively low scattering loss of <10 dB/km at a data transmission wavelength or wavelength range λ_{D} that lies in an IR portion of the optical spectrum;
the optical tracer fiber is physically coupled to or surrounded by the cable jacket and defines a tracer scattering profile comprising a relatively high scattering loss of >15 dB/km at a tracer wavelength between about 400 nm and about 700 nm or a tracer wavelength range λ_{T} that lies between about 400 nm and about 700 nm in a visible portion of the optical spectrum such that visible light at the tracer wavelength or wavelength range λ_{T} is dispersed from the optical tracer fiber along at least a portion of its length;
at a bend radius of less than approximately 25 mm, (i) the tracer scattering profile of the optical tracer fiber generates dispersed visible light of a luminance that is at least about 2 times greater than dispersed visible light generated in a zero-bend portion of the optical tracer fiber at the tracer wavelength or wavelength range λ_{T}, or an optically visible shifted tracer wavelength or wavelength range λ_{T}*, and (ii) a tracer bending loss of the optical tracer fiber is at least about 10 times greater than a data transmission bending loss of the optical data transmission fiber, at the respective wavelengths or wavelength ranges λ_{T}, λ_{D};
an optical intensity of the tracer light source at the tracer wavelength or wavelength range λ_{T} is sufficient for the luminance of the dispersed visible light at λ_{T} or λ_{T}* to be at least approximately 80 cd/m² at a bend radius of less than approximately 25 mm; and
the optical fiber cable assembly is configured such that the dispersed visible light at the tracer wavelength or wavelength range λ_{T} or an optically visible shifted tracer wavelength or wavelength range λ_{T}* is visible from an exterior of the optical fiber cable assembly.

2. The optical fiber cable assembly as claimed in claim 1 wherein, at a bend radius of between approximately 10 mm and approximately 25 mm, the tracer scattering profile of the optical tracer fiber generates dispersed visible light of a luminance that is at least about two times greater than dispersed visible light generated in a zero-bend portion of the optical tracer fiber.

3. The optical fiber cable assembly as claimed in claim 1 wherein, at a bend radius of between approximately 2 mm and approximately 15 mm, the tracer scattering profile of the optical tracer fiber generates dispersed visible light of a luminance that is at least about five times greater than dispersed visible light generated in a zero-bend portion of the optical tracer fiber.

4. The optical fiber cable assembly as claimed in claim 1 wherein, at a bend radius of between approximately 2 mm and approximately 5 mm, the tracer scattering profile of the optical tracer fiber generates dispersed visible light of a luminance that is at least about fifteen times greater than dispersed visible light generated in a zero-bend portion of the optical tracer fiber.

5. The optical fiber cable assembly as claimed in claim 1 wherein:
the optical data transmission fibers are characterized by a bend sensitivity threshold at a data transmission bend radius r₁; and
the tracer scattering profile of the optical tracer fiber generates at least about a two-fold increase in the luminance of the dispersed visible light at a bend sensitive tracer bend radius r₂ that is larger than the data transmission bend radius r₁.

6. The optical fiber cable assembly as claimed in claim 5 wherein the bend sensitive tracer bend radius r₂ is within approximately 5 mm of the bend sensitive data transmission bend radius r₁.

7. The optical fiber cable assembly as claimed in claim 1 wherein:
the tracer scattering profile of the optical tracer fiber and the optical intensity of the optical tracer source are such that visible light at the tracer wavelength or wavelength range λ_{T} is dispersed from zero-bend portions of the optical tracer fiber at a luminance that is at least about 10 cd/m².

8. The optical fiber cable assembly as claimed in claim 1 wherein:
the tracer scattering profile of the optical tracer fiber and the optical intensity of the optical tracer source are such that visible light at the tracer wavelength or wavelength range λ_{T} is dispersed from zero-bend portions of the optical tracer fiber at a luminance that is between approximately 10 cd/m² and approximately 50 cd/m²; and
the tracer scattering profile of the optical tracer fiber and the optical intensity of the optical tracer source are such that the dispersed visible light λ_{T}, λ_{T}* comprises a luminance between approximately 100 cd/m² and approximately 200 cd/m² at bend radii of approximately 20 mm and below.

9. The optical fiber cable assembly as claimed in claim 1 wherein:
the tracer scattering profile of the optical tracer fiber is such that visible light at the tracer wavelength or wavelength range λ_{T} is dispersed from zero-bend portions of the optical tracer fiber at a luminance that is less than 10 cd/m².

10. The optical fiber cable assembly as claimed in claim 9 wherein:
the tracer scattering profile of the optical tracer fiber and the optical intensity of the optical tracer source are such that the dispersed visible light λ_{T}, λ_{T}* comprises a luminance between approximately 80 cd/m² and approximately 200 cd/m² at bend radii of approximately 20 mm and below.

11. The optical fiber cable assembly as claimed in claim 1 wherein:
the tracer scattering profile of the optical tracer fiber and the optical intensity of the optical tracer source are such that visible light at the tracer wavelength or wavelength range λ_{T} is dispersed from zero-bend portions of the optical tracer fiber at a luminance that is at least about 80 cd/m²;
the optical fiber cable assembly is configured such that the dispersed visible light λ_{T}, λ_{T}* is visible from an exterior of the optical fiber cable assembly as a color-coded, patterned, or symbolic emission.

12. The optical fiber cable assembly as claimed in claim 1 wherein:
the optical fiber cable assembly is terminated at opposite ends by optical connectors;
the optical fiber cable assembly comprises a tracer light source injection port to optically couple the tracer light source to the optical tracer fiber; and
the tracer light source injection port is positioned along a length of the optical fiber cable assembly between the optical connectors of the optical fiber cable assembly.

13. The optical fiber cable assembly as claimed in claim 1 wherein the optical fiber cable assembly is terminated at opposite ends by optical connectors, at least one of which is configured to permit the injection of light from the tracer light source into the optical tracer fiber of the cable assembly.

14. The optical fiber cable assembly as claimed in claim 1 wherein:
the optical tracer fiber is positioned within an inside diameter of the cable jacket;
the cable jacket is visible from an exterior of the optical fiber cable assembly and is translucent or transparent to the tracer wavelength or wavelength range λ_{T} or the optically visible shifted tracer wavelength or wavelength range λ_{T}*, or transmits the optically visible shifted tracer wavelength or wavelength range λ_{T}*, along at least a portion of a length of the optical fiber cable assembly;
the cable jacket comprises transmissive, translucent, or transparent regions that are configured to permit the propagation or transmission of the tracer wavelength or wavelength range λ_{T} or the optically visible shifted tracer wavelength or wavelength range λ_{T}*; and
the transmissive, translucent, or transparent regions comprise transmissive, translucent, or transparent voids or plugs in the cable jacket.

15. The optical fiber cable assembly as claimed in claim 14 wherein:
the optical fiber cable assembly further comprises hygroscopic material interposed between the optical tracer fiber and the cable jacket; and
the hygroscopic tape comprises transmissive, translucent, or transparent regions that permit propagation of the tracer wavelength or wavelength range λ_{T} or the optically visible shifted tracer wavelength or wavelength range λ_{T}* from the optical tracer fiber to the cable jacket.

16. The optical fiber cable assembly as claimed in claim 1 wherein:
the optical tracer fiber is positioned between an inside diameter of the cable jacket and an outside diameter of the cable jacket; and
the cable jacket is visible from an exterior of the optical fiber cable assembly and is translucent or transparent to the tracer wavelength or wavelength range λ_{T} or the optically visible shifted tracer wavelength or wavelength range λ_{T}* along at least a portion of a length of the optical fiber cable assembly.

17. The optical fiber cable assembly as claimed in claim 1 wherein the optical tracer fiber comprises a tracer jacket and is positioned on an outside diameter of the cable jacket or is positioned to at least partially extend beyond an outside diameter of the cable jacket.

18. The optical fiber cable assembly as claimed in claim 1 wherein the tracer light source emits an optical output at the tracer wavelength or wavelength range λ_{T} that is pulsed at a frequency of less than approximately 40 Hz.

19. An optical fiber cable assembly comprising a tracer light source, at least one optical tracer fiber, one or more optical data transmission fibers, and a cable jacket, wherein:
the optical data transmission fibers are surrounded by the cable jacket and define a data transmission profile comprising a relatively low scattering loss of <10 dB/km at a data transmission wavelength or wavelength range λ_{D} that lies in a non-visible portion of the optical spectrum;
the optical tracer fiber is physically coupled to or surrounded by the cable jacket and defines a tracer scattering profile comprising a relatively high scattering loss of >15 dB/km at a non-visible tracer wavelength or a non-visible tracer wavelength range λ_{T} such that non-visible light at the tracer wavelength or wavelength range λ_{T} is dispersed from the optical tracer fiber along at least a portion of its length;
at a bend radius of less than approximately 25 mm, (i) the tracer scattering profile of the optical tracer fiber generates dispersed light of a luminance that is at least about 2 times greater than dispersed light generated in a zero-bend portion of the optical tracer fiber at the tracer wavelength or wavelength range λ_{T}, or an optically shifted tracer wavelength or wavelength range λ_{T}*, and (ii) a tracer bending loss of the optical tracer fiber is at least about 10 times greater than a data transmission bending loss of the optical data transmission fiber, at the respective wavelengths or wavelength ranges λ_{T}, λ_{D};
an optical intensity of the tracer light source at the tracer wavelength or wavelength range λ_{T} is sufficient for the luminance of the dispersed light at λ_{T} or λ_{T}* to be at least approximately 80 cd/m² at a bend radius of less than approximately 25 mm; and
the optical fiber cable assembly is configured such that the dispersed light at the tracer wavelength or wavelength range λ_{T} or an optically shifted tracer wavelength or wavelength range λ_{T}* is detectable from an exterior of the optical fiber cable assembly.

20. The optical fiber cable assembly as claimed in claim 19, wherein the optical tracer fiber defines a tracer scattering profile comprising a relatively high scattering loss of >15 dB/km at an infrared wavelength or an infrared wavelength range λ_{T} such that infrared light at the tracer wavelength or wavelength range λ_{T} is dispersed from the optical tracer fiber along at least a portion of its length.

21. The optical fiber cable assembly as claimed in claim 19, wherein the optical tracer fiber defines a tracer scattering profile comprising a relatively high scattering loss of >15 dB/km at a wavelength between about 700 nanometers to about 2 microns or an wavelength range λ_{T} between about 700 nanometers to about 2 microns such that light at the tracer wavelength or wavelength range λ_{T} is dispersed from the optical tracer fiber along at least a portion of its length
